(19) United States
(12) Patent Application Publication
(10) Pub. No.: US 2008/0091411 A1
(43) Pub. Date: Apr. 17, 2008

(54) Method for identifying a meaning of a word capable of identifying several meanings

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/974,310

(22) Filed: Oct. 12, 2007

Related U.S. Application Data
(60) Provisional application No. 60/851,227, filed on Oct. 12, 2006.
(60) Provisional application No. 60/854,664, filed on Oct. 25, 2006.

(51) Int. Cl. G06F 17/27

(52) U.S. Cl. 704/9

(57) ABSTRACT

A series of methods and systems for identifying a meaning or plurality of meanings of a word are disclosed for registering, searching and/or retrieving information. In one embodiment, a person identifies a word and a meaning is selected or added. In addition, the methods further suggest the implementation of other words or synonyms for identifying the intended meaning by said word.

### DESCRIPTION OF RELATED ART

The revolution of the Internet is responsible for several new search engine technologies which provide many valuable features and capabilities aimed to assist the users find the information they are looking for. However, the complexity of many words and languages engender many difficult barriers to current technologies to search and retrieve superior results. For example, many words, here introduced as “multi-conceptual” words, are capable of identifying several meanings. Such would be the case of the word “blue,” which in one instant can be used to identify a color, and in another instant can be used to identify sadness. As a consequence, current searched results potentially include both meanings under a single display or group of results, confusing and mismanaging the user's time and effort. Recent efforts such as that of U.S. patent application Ser. No. 11/716,315 filed by the present inventor, involve the implementation of several identifiers, each used to identify a single meaning of a multi-conceptual word. In such fashion, the search engine can group the results based on each of the identifiers thus assembling the results by their meanings. However, such system requires the formation of extensive relational databases and faces the possibility to be slow to react to mistakes, new words, and meanings since the system is automated and fully dependent on the integrity of said databases and their inputs.

In view of the present and envisioned shortcomings and limitations, the present invention distinguishes over the prior art by providing heretofore a broader and more compelling method to identify a meaning or lesser number of meanings of a word capable of identifying a variety of meanings, allowing to register said single or lesser meanings for searching, retrieving and ultimately producing superior results and information while providing additional unknown, unsolved and unrecognized advantages as described in the following summary.

### SUMMARY OF THE INVENTION

The present invention teaches certain benefits in use and construction which give rise to the objectives and advantages described below. The methods embodied by the present invention overcome the limitations and shortcomings encountered when identifying and ultimately searching, retrieving, and producing results containing multi-conceptual words (words capable of identifying several meanings) by bestowing the identifying action of said multi-conceptual words to at least one of a: information providing entity, information searching entity, and information analyzing entity.

### OBJECTS AND ADVANTAGES

A primary objective inherent in the above described method of use is to provide a means and methods for identifying a meaning of a multi-conceptual word present in a corpus of information not taught by the prior arts and further advantages and objectives not taught by the prior art. Accordingly, several objects and advantages of the invention are:

Another objective is to quickly identify newly introduced meanings of a multi-conceptual word in a corpus of information;

Another objective is to quickly identify a new introduced meaning of a current word for identifying said word as a new multi-conceptual word;

Another objective is to improve search results;

A further objective is to allow automated methods and manual methods to incorporate each other;

A further objective is to save automation by implementing the resources of the information providing entities;

A further objective is to simplify conceptualization of information by possibly suggesting the information providing entities to implement less complex words;

A further objective is to reduce irrelevance;

A further objective is to control irrelevance;

A further objective is to stimulate the conceptualization of data;

A further objective is to permit the retrieval of relevant archaic information implementing modern language;

Other features and advantages of the described methods of use will become apparent from the following more detailed description, taken in conjunction with the accompanying drawings, which illustrate, by way of example, the principles of the presently described method and its use.

### BRIEF DESCRIPTION OF THE DRAWINGS

The accompanying drawings illustrate at least one of the best mode embodiments of the present methods of use. In such drawings:

FIG. 1 is a non-limiting block diagram of the elementary steps of the primary inventive method;

FIG. 2 is an exemplary illustration of the elementary steps of the primary inventive method disclosed in FIG. 1;

FIGS. 3A and 3B are non-limiting illustrations of the results by a search engine, containing websites identified as not fully conceptualized since they contain words with meanings that are not yet identified;

FIG. 4 illustrates a non-limiting example of results grouped or arrayed by meaning;

FIG. 5 is a non-limiting sampling illustration of the “exemplary and suggestive” function for allowing a user to review, enter and/or select other word or information for identifying the intended meaning;

FIG. 6 is a non-limiting block diagram of exemplary steps of a another method or modification of the primary inventive method;

FIG. 7 is a non-limiting exemplary illustration of the steps depicted in FIG. 6;

FIG. 8 is a non-limiting sampling illustration of further variation of the method depicted in FIG. 6 and FIG. 7.

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

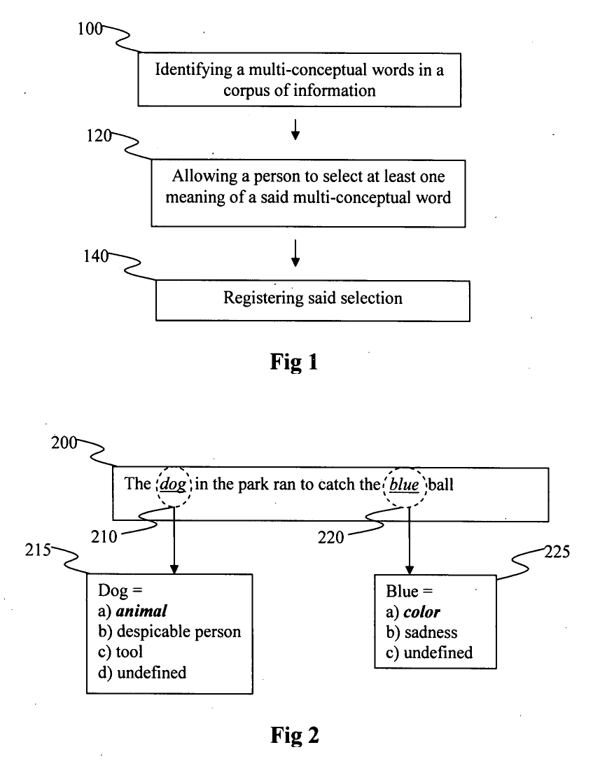

FIG. 1 illustrates a non-limiting general block diagram of the elementary steps of the primary inventive method. The initial step 100 (FIG. 1) involves the step of identifying a multi-conceptual word in a corpus of information. The second step 120 (FIG. 1) involves allowing a person to select or choose at least one meaning of said identified multi-conceptual word. The final step 140 (FIG. 1) involves the action of registering said selection of at least one said meaning of the said multi-conceptual word.

FIG. 2 is an exemplary illustration of the elementary steps of the primary inventive method depicted in FIG. 1. The corpus of information 200 (FIG. 2) contains a plurality of multi-conceptual words being identified by means of an underline. The first underlined multi-conceptual word 210 (FIG. 2) in the corpus of information is the word “dog.” By right-clicking the word (or other type of action) produces a drop-down menu 215 (FIG. 2) containing several meanings of the word “dog.” In this example, the person obviously chooses the first or (a) option on the first drop-down menu 215 (FIG. 2) for selecting the meaning of that of an animal. The second identified multi-conceptual word 220 (FIG. 2) is the word “blue.” Once again, the person can access the drop-down menu 225 (FIG. 2) for selecting a meaning that the word “blue” assumes in the corpus of information. From this sample, the correct selection would be that of option (a) or the meaning of “color.” Noteworthy, those multi-conceptual words which their meanings have not yet being identified can use an unidentified type of identifier until some one or something is capable of selecting a meaning. In such fashion, words and corpuses of information which have not yet being fully conceptualized can be treated differently since there are capable of promoting and displaying irrelevance.

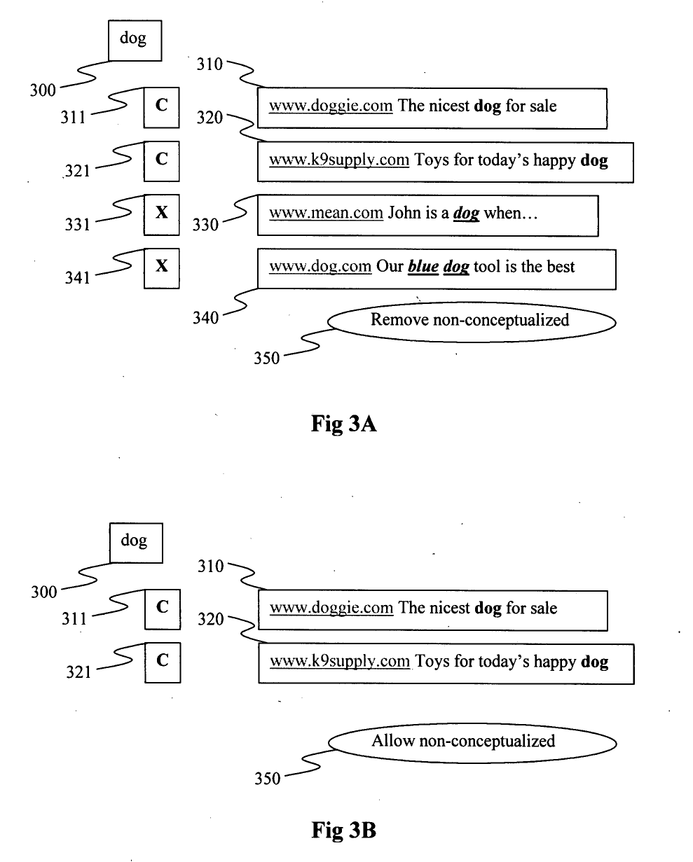

FIGS. 3A and 3B are non-limiting illustrations of the results generated by a search engine in response to a query such as “dog;” wherein the results contain websites that have not yet being fully conceptualized and therefore identified as such. Accordingly, the user is able to identify or prospectively control irrelevant results. In FIG. 3A the query 300 (FIG. 3A) “dog” produced a total of 4 websites. The first website 310 (FIG. 3A) contains the word “dog” as an animal, and its “C” symbol 311 (FIG. 3A) identifies that the website is fully conceptualized, in other words, all meanings for all the words have properly being identified. In similar fashion, the second website 320 (FIG. 3A) contains “dog” as an animal and is fully conceptualized as illustrated by its “C” symbol 321 (FIG. 3A). However, the third website 330 (FIG. 3A) displays the word “dog” in Italic text and underlined indicating that its meaning has not yet being selected or identified. As a consequence, its conceptual symbol 331 (FIG. 3A) displays the letter “X” identifying that the website contains data capable of producing irrelevance and/or obscure information. The fourth website 340 (FIG. 3A) contains two words “blue” and “dog,” again identified in Italic and underlined indicating that both words are not yet conceptualized or that their meaning has not yet being selected. Therefore, its conceptual symbol 341 (FIG. 3A) displays an “X” for identifying that the website contains data that is not yet conceptualized and thus capable of generating irrelevance. The control button 350 (FIG. 3A) named “remove non-conceptualized” allows the user click or active the function to control, remove or filter out those websites containing non-conceptualized data. FIG. 3B illustrates the websites the search engine produces when said “remove non-conceptualized” function is requested. The results contain only those websites with fully conceptualized data. In this example, the query 300 (FIG. 3B) displays those websites such as the first website 310 (FIG. 3B) along with its Conceptual Identifier 311 (FIG. 3B), and the second website 320 (FIG. 3B) along with its respective “C” symbol 321 (FIG. 3B) or Conceptual Identifier indicating that their data or content is fully conceptualized. The control button 350 (FIG. 3B) now displays the name “allow non-conceptualized” permitting the user to click it, for including all websites, even those containing possible irrelevant (non-conceptualized) data.

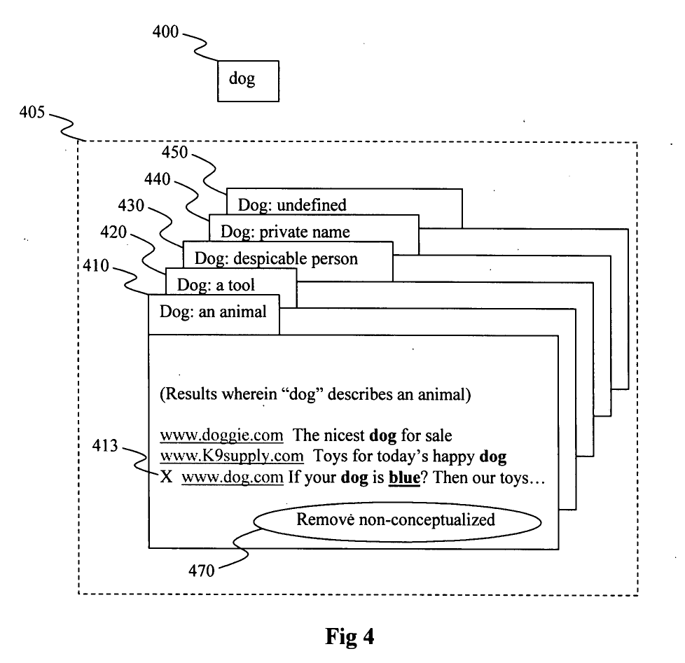

FIG. 4 illustrates a non-limiting example of results grouped by meaning. The query 400 (FIG. 4) of the multi-conceptual word “dog” produces several arrays of results 405 (FIG. 4). In the first array or group 410 (FIG. 4) all those websites containing the word “dog;” wherein “dog” is identifying an animal are displayed or grouped together. Clicking on the second tab or group 420 (FIG. 4) will display all those websites containing the word “dog;” wherein dog is now used to identify a tool as mentioned by its tab. In similar fashion, the third group 430 (FIG. 4) and the fourth group 440 (FIG. 4) implement “dog” to describe their respective meanings as illustrated by their tabs. The fifth group 450 (FIG. 4) contains all those websites wherein the word “dog” has yet an unidentified meaning, in other words, the meaning of the word “dog” in such sites is still unknown. Please note, in the first group 410 (FIG. 4), there is a website still containing unidentified information. The third website 413 (FIG. 4) is been identified with an “X” depicting its unfulfilled conceptualization status. In this website, the meaning of “dog” is known (an animal); but the meaning of the adjacent word of “blue” is not yet identified, thus being displayed in underlined bold text in addition to a question mark (? symbol). Also illustrated in FIG. 4 is the conceptualized filter button 470 (FIG. 4), again for removing potentially confusing and/or not fully conceptualized information from the present array and/or any other array.

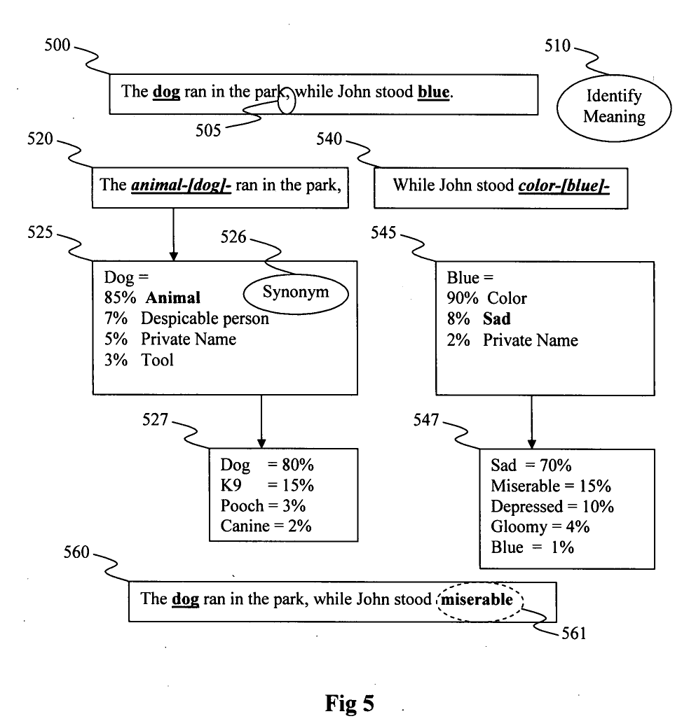

FIG. 5 is a non-limiting sample illustration of the “exemplary and suggestive” function for allowing a user to review, enter and/or select information. In this example, a person is provided with the corpus of information 500 (FIG. 5) for review. The “Identify Meaning” button 510 (FIG. 5) is clicked by the person to active its function. As a result, the corpus of information is reproduced implementing the most likely meaning and/or sampling words such as synonyms. In this particular example, the colon 505 (FIG. 5) is utilized to divide the corpus of information into to smaller corpuses. Respectively, the first “Meaning and Exemplary Identifying Data” 520 (FIG. 5) the multi-conceptual word “dog” was changed or substituted with its most likely meaning or the word “animal” as an exemplary model of its possible concept. In addition, the “Meanings Table” 525 (FIG. 5) for “dog” is displayed underneath, allowing the user to select other meaning than the suggested one. In fact, the “Meanings Table” also displays the percentage that the word “dog” is used to identify an animal versus other meanings it can potentially represent or assume. Furthermore, clicking the “Synonyms” button 526 (FIG. 5) produces the “Synonyms Menu” 527 (FIG. 5) for selecting other synonym or possibly better, most common word. As illustrated, the “Synonyms Menu” 527 (FIG. 5) also depicts the most likely or most common synonym in the group, thus suggesting the user to select it for better and more simple content comprehension. In similar fashion, the second “Meaning and Exemplary Identifying Data” 540 (FIG. 5) displays a section of the corpus of information substituting the multi-conceptual word “blue” with its most likely meaning of “color.” As a result, the phrase has no conceptual coherence. Underneath, is its “Meanings Table” 545 (FIG. 5) which will allow the user to change the meaning, not only selecting the correct identifier (meaning), but also suggesting the replacement of the word “blue” with other more commonly used word such as “sad.” Accordingly, clicking on the word “sad” would change or select the word's meaning to that of the concept of sadness. In this example, the “Synonyms Menu” 547 (FIG. 5) also appears displaying other words or synonyms that can suggestively be used to identify the intended “sadness” meaning by implementing other better and more cognitive words than “blue.” In such fashion, the meanings and most commonly used words can be selected. As a result, the new converted corpus 560 (FIG. 5) now illustrates the revised text including the implementation of a different word or synonym or miserable 561 (FIG. 5), which better depicts the intended concept or data.

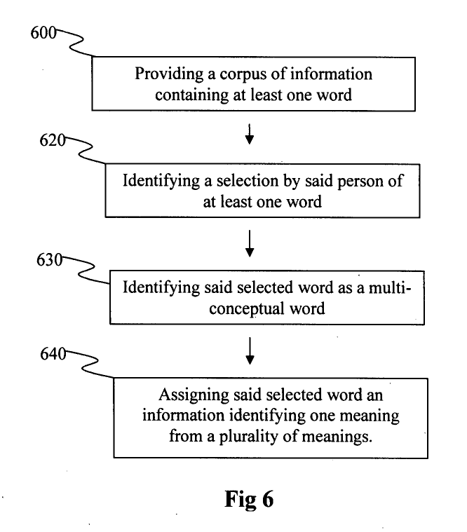

FIG. 6 is a non-limiting block diagram of exemplary steps of another method or modification of the inventive methods. The first step 600 (FIG. 6) involves providing a corpus of information to a person containing at least one word. The second step 620 (FIG. 6) involves the implementation of said person for identifying and/or selecting a word in said corpus of information which is not being identified as a multi-conceptual word, such as highlighting it. The next step 630 (FIG. 6) involves identifying or acknowledging the said selection by the said person, such as identifying the word as a new multi-conceptual word. The next and final step 640 (FIG. 6) involves assigning the said word at least one information for identifying at least one meaning from a plurality of meanings of said word. In such fashion, new multi-conceptual words can be quickly identified.

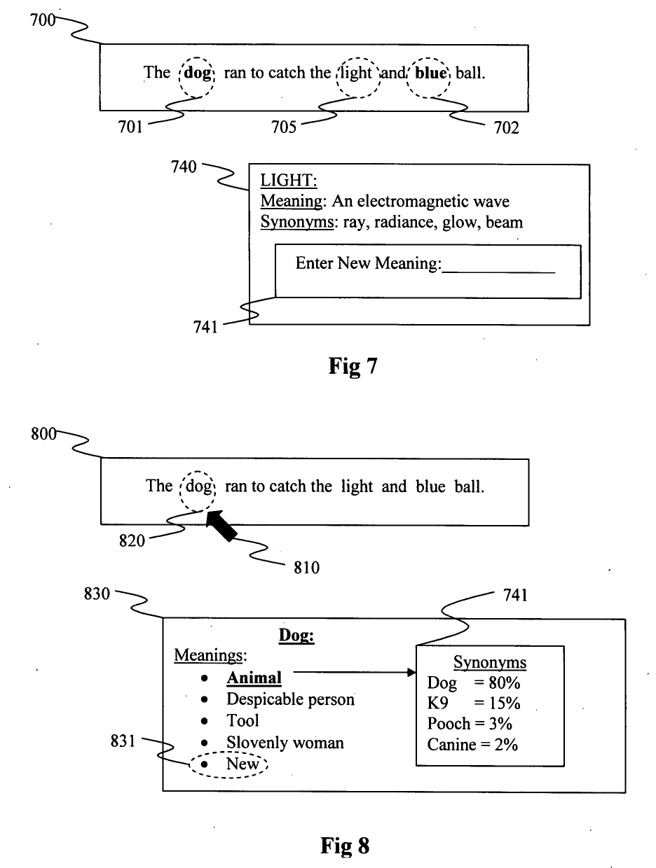

FIG. 7 is a non-limiting exemplary illustration of the steps from FIG. 6. The corpus of information 700 (FIG. 7) is provided to a person for analysis comprising several multi-conceptual words such as the first identified multi-conceptual word 701 (FIG. 7) and the second identified multi-conceptual word 702 (FIG. 7). Upon reading and/or discovering the said corpus of information, the person identifies a new or another multi-conceptual word 705 (FIG. 7) which currently is not being identified. Consequentially, the person highlights the non-identified word 705 (FIG. 7) in order to identify it as a word comprising several meanings. Optionally the Meanings Table 740 (FIG. 7) appears for allowing the person to add or introduce at least one new or non-identified meaning in the Enter New Meaning Field 741 (FIG. 7).

FIG. 8 illustrates a non-limiting example of a further variation of the inventive method depicted in FIG. 6 and FIG. 7. The corpus of information 800 (FIG. 8) is provided to a user. Simply by placing the cursor 810 (FIG. 8) or right-clicking a word 820 (FIG. 8), the word's meaning window 830 (FIG. 8) is displayed allowing the viewer to see the meaning(s) and/or nature that the word has in the particular corpus of data. Consequentially, the user can choose a meaning from the current meaning's menu and/or a new meaning to the selected word 820 (FIG. 8). In addition, the user can select the most commonly used word (synonym) to identify the intended concept. In such fashion any word present in the said corpus of information can be manually conceptualized. Furthermore, the new meaning option 831 (FIG. 8) will allow the user to quickly enter or add a new meaning to the word.

Noteworthy, any of the disclosed and/or ramification methods may included the additional step of verifying the selection(s) and/or addition of a meaning to a word, including modifying, approving, ignoring, and declining said meanings.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a series of novel methods for identifying, selecting, and adding a meaning of a word can be appreciated. The described methods overcome the limitations encountered when submitting information comprising complex and multi-conceptual words which are capable of promoting irrelevance primarily when searching and retrieving information. Furthermore, the foregoing methods are capable of suggesting other less complex words improving the conceptualization of information providing entities, information searching and ultimately and most importantly, its readers.

1. A method for identifying a meaning of a word comprising the steps of:
a) Identifying a word in a corpus of information; wherein said word is capable of identifying a plurality of meanings,
b) Identifying a selection of at least one meaning of said word,
c) Implementing an information for identifying at least one meaning of said word.

2. A method for identifying a new meaning of a word comprising the steps of:
a) Providing a corpus of information comprising at least one word,
b) Identifying a selection of a word in said corpus of information,
c) Identifying said selected word as a word comprising a plurality of meanings,
d) Implementing an information for identifying a meaning of said plurality of meanings.

3. The method of claim 2 comprising the additional step of:
a) Providing inputting means for entering at least one meaning of said word.

4. A method for registering a meaning of a word comprising the steps of:
a) Identifying a selection of a word,
b) Displaying a plurality of meanings of said word,
c) Identifying a selection of at least one meaning of said word,
d) Associating said selected meaning and said selected word.
